(19) United States
(12) Patent Application Publication
(10) Pub. No.: US 2017/0034843 A1
(43) Pub. Date: Feb. 2, 2017

(54) SCHEDULER METHODS FOR DATA AGGREGATION OVER MULTIPLE LINKS

(71) Applicant: QUALCOMM Incorporated, San Diego, CA (US)

(72) Inventors: Feilu Liu, San Diego, CA (US); Aziz Gholmieh, Del Mar, CA (US); Vikas Jain, San Diego, CA (US)

(21) Appl. No.: 15/218,830

(22) Filed: Jul. 25, 2016

Related U.S. Application Data
(60) Provisional application No. 62/198,617, filed on Jul. 29, 2015.

(51) Int. Cl. H04W 72/12; H04L 12/875; H04W 56/00

(52) U.S. Cl. CPC H04W 72/1231; H04W 56/004; H04L 47/56

(57) ABSTRACT

Techniques for scheduling data for transmission over multiple links are described herein. For example, techniques described herein include adding extra delay at low-delay link and/or allocating long-delay links with newer and/or higher sequence number packets and low-delay links with older and/or lower sequence number packets. Additional or alternative techniques disclosed herein include disabling multi-link under low throughput, and/or avoiding overflow using history information. Additional or alternative techniques disclosed herein include normalizing data size into time and/or buffer size configuration.

### CROSS-REFERENCE TO RELATED APPLICATIONS

This application claims the benefit of U.S. Provisional Patent Application No. 62/198,617, entitled, Scheduler Methods for Data Aggregation over Multiple Links,” filed on Jul. 29, 2015, which is expressly incorporated by reference herein in its entirety.

### BACKGROUND

Field

Aspects of the present disclosure relate generally to wireless communication systems, and more particularly, to scheduler methods for data aggregation over multiple links.

Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

Features like dual connectivity and 3GPP Long Term Evolution (LTE) Wireless Local Area Network (WLAN) Packet Data Convergence Protocol (PDCP) aggregation distribute traffic over multiple links. The delay of each link may be different, resulting in out of sequence arrival of packets at the receiver side. The delivered packets may be reordered at the receiver side. However, significant difference in link delay may result in receiver side reordering timeout and high usage of memory and central processing unit (CPU) resources.

### SUMMARY

Techniques for scheduling data for transmission over multiple links are described herein. For example, techniques described herein include adding extra delay at low-delay link and/or allocating long-delay links with newer and/or higher sequence number packets and low-delay links with older and/or lower sequence number packets. Additional or alternative techniques disclosed herein include disabling multi-link under low throughput, and/or avoiding overflow using history information. Additional or alternative techniques disclosed herein include normalizing data size into time and/or buffer size configuration.

In an aspect, a method of scheduling and transmitting data over multiple links includes determining a difference between a first delay of a first link and a second delay of a second link. The first delay is equal to a time duration of delivery of data over the first link. The second delay is equal to a time duration of delivery of data over the second link. The method additionally includes adding delay to the second link when the first delay is larger than the second delay. The method also includes, adding delay to the first link when the second delay is larger than the first delay. The method further includes transmitting data, when the first delay is larger than the second delay, over the first link and the second link according to the delay added to the second link. The method further includes transmitting data, when the second delay is larger than the first delay, over the first link and the second link according to the delay added to the first link.

In another aspect, a transmitter apparatus includes means for determining a difference between a first delay of a first link and a second delay of a second link. The first delay is equal to a time duration of delivery of data over the first link. The second delay is equal to a time duration of delivery of data over the second link. The transmitter apparatus additionally includes means for adding delay to the second link when the first delay is larger than the second delay. The transmitter apparatus also includes means for adding delay the first link when the second delay is larger than the first delay. The transmitter apparatus further includes means for transmitting data, when the first delay is larger than the second delay, over the first link and the second link according to the delay added to the second link. The transmitter apparatus further includes means for transmitting data, when the second delay is larger than the first delay, over the first link and the second link according to the delay added to the first link.

In another aspect, a computer program product comprises a non-transitory computer-readable medium having instructions recorded thereon that, when enacted by one or more computer processors, cause the one or more computer processors to carry out operations. For example, the operations include determining a difference between a first delay of a first link and a second delay of a second link. The first delay is equal to a time duration of delivery of data over the first link. The second delay is equal to a time duration of delivery of data over the second link. The operations additionally include adding delay to the second link when the first delay is larger than the second delay. The operations also include adding delay the first link when the second delay is larger than the first delay. The operations further include transmitting data, when the first delay is larger than the second delay, over the first link and the second link according to the delay added to the second link. The operations additionally include transmitting data, when the second delay is larger than the first delay, over the first link and the second link according to the delay added to the first link.

In another aspect, a transmitter apparatus includes one or more processors configured to determine a difference between a first delay of a first link and a second delay of a second link, and add delay to the second link when the first delay is larger than the second delay. The first delay is equal to a time duration of delivery of data over the first link. The second delay is equal to a time duration of delivery of data over the second link. The one or more processors are further configured to add delay the first link when the second delay is larger than the first delay. The one or more processors are further configured to transmit data, when the first delay is larger than the second delay, over the first link and the second link according to the delay added to the second link. The one or more processors are further configured to transmit data, when the second delay is larger than the first delay, over the first link and the second link according to the delay added to the first link. The transmitter apparatus further includes at least one memory coupled to the one or more processors.

In another aspect, a method of scheduling and transmitting data over multiple links includes determining whether a first delay of a first link is larger than a second delay of a second link. The method additionally includes, allocating newer packets to the first link and older packets to the second link when the first delay is larger than the second delay. The method also includes allocating newer packets to the second link and older packets to the first link when the second delay is larger than the first delay. The method further includes transmitting the allocated newer packets over the first link and the allocated older packets over the second link when the first delay is larger than the second delay. The method further includes transmitting the allocated newer packets over the second link and the allocated older packets over the first link when the second delay is larger than the first delay.

In another aspect, a transmitter apparatus includes means for determining whether a first delay of a first link is larger than a second delay of a second link, and means for allocating newer packets to the first link and older packets to the second link when the first delay is larger than the second delay. The transmitter apparatus additionally includes means for allocating newer packets to the second link and older packets to the first link when the second delay is larger than the first delay, and means for transmitting the allocated newer packets over the first link and the allocated older packets over the second link when the first delay is larger than the second delay. The transmitter apparatus further includes means for transmitting the allocated newer packets over the second link and the allocated older packets over the first link when the second delay is larger than the first delay.

In another aspect, a computer program product comprises a non-transitory computer-readable medium having instructions recorded thereon that, when enacted by one or more computer processors, cause the one or more computer processors to carry out operations. For example, the operations include determining whether a first delay of a first link is larger than a second delay of a second link, and allocating newer packets to the first link and older packets to the second link when the first delay is larger than the second delay. The operations further include allocating newer packets to the second link and older packets to the first link when the second delay is larger than the first delay. The operations further include transmitting the allocated newer packets over the first link and the allocated older packets over the second link when the first delay is larger than the second delay. The operations further include transmitting the allocated newer packets over the second link and the allocated older packets over the first link when the second delay is larger than the first delay.

In another aspect, a transmitter apparatus includes one or more computer processors configured to determine whether a first delay of a first link is larger than a second delay of a second link, and allocate newer packets to the first link and older packets to the second link when the first delay is larger than the second delay. The one or more computer processors are further configured to allocate newer packets to the second link and older packets to the first link when the second delay is larger than the first delay. The one or more computer processors are further configured to transmit the allocated newer packets over the first link and the allocated older packets over the second link when the first delay is larger than the second delay. The one or more computer processors are further configured to transmit the allocated newer packets over the second link and the allocated older packets over the first link when the second delay is larger than the first delay. The transmitter apparatus also includes at least one memory coupled to the one or more computer processors.

In another aspect, a method of scheduling and transmitting data over multiple links includes determining at least one of average link data rate, link throughputs, or delay of at least one of a first link or a second link. The method additionally includes determining a threshold based on the at least one of the average link data rate, the link throughputs, or the delay. The method also includes determining a traffic arrival rate, and comparing the traffic arrival rate to the threshold. The method further includes distributing traffic to both the first link and the second link when the traffic arrival rate is greater than the threshold. The method further includes distributing traffic to only one of the first link or the second link when the traffic arrival rate is less than the threshold. The method further includes transmitting the distributed traffic over at least one of the first link or the second link.

In another aspect a transmitter apparatus includes means for determining at least one of average link data rate, link throughputs, or delay of at least one of a first link or a second link. The transmitter apparatus additionally includes means for determining a threshold based on the at least one of the average link data rate, the link throughputs, or the delay. The transmitter apparatus also includes means for determining a traffic arrival rate, and means for comparing the traffic arrival rate to the threshold. The transmitter apparatus further includes means for distributing traffic to both the first link and the second link when the traffic arrival rate is greater than the threshold. The transmitter apparatus further includes means for distributing traffic to only one of the first link or the second link when the traffic arrival rate is less than the threshold. The transmitter apparatus further includes means for transmitting the distributed traffic over at least one of the first link or the second link.

In another aspect, a computer program product comprises a non-transitory computer-readable medium having instructions recorded thereon that, when enacted by one or more computer processors, cause the one or more computer processors to carry out operations. For example, the operations include determining at least one of average link data rate, link throughputs, or delay of at least one of a first link or a second link, and determining a threshold based on the at least one of the average link data rate, the link throughputs, or the delay. The operations also include determining a traffic arrival rate, and comparing the traffic arrival rate to the threshold. The operations further include distributing traffic to both the first link and the second link when the traffic arrival rate is greater than the threshold, and distributing traffic to only one of the first link or the second link when the traffic arrival rate is less than the threshold. operations further include transmitting the distributed traffic over at least one of the first link or the second link.

In another aspect, a transmitter apparatus includes one or more computer processors configured to determine at least one of average link data rate, link throughputs, or delay of at least one of a first link or a second link, and determine a threshold based on the at least one of the average link data rate, the link throughputs, or the delay. The one or more computer processors are further configured to determine a traffic arrival rate, and compare the traffic arrival rate to the threshold. The one or more computer processors are further configured to distribute traffic to both the first link and the second link when the traffic arrival rate is greater than the threshold, and distribute traffic to only one of the first link or the second link when the traffic arrival rate is less than the threshold. The one or more computer processors are further configured to transmit the distributed traffic over at least one of the first link or the second link. The transmitter apparatus also includes at least one memory coupled to the one or more computer processors.

In another aspect, a method of scheduling and transmitting data over a link of multiple links includes distributing data to a link such that transmission buffer occupancy of the link is lower than or equal to a given limit. The method also includes transmitting the distributed data over the link.

In another aspect, a transmitter apparatus includes means for distributing data to a link such that transmission buffer occupancy of the link is lower than or equal to a given limit, the transmitter apparatus also includes means for transmitting the distributed data over the link.

In another aspect, a computer program product comprising a non-transitory computer-readable medium having instructions recorded thereon that, when enacted by one or more computer processors, cause the one or more computer processors to carry out operations. For example, the operations include distributing data to a link such that transmission buffer occupancy of the link is lower than or equal to a given limit. The operations also include transmitting the distributed data over the link.

In another aspect, a transmitter apparatus includes one or more computer processors configured to distribute data to a link such that transmission buffer occupancy of the link is lower than or equal to a given limit. The one or more computer processors are also configured to transmit the distributed data over the link. The transmitter apparatus also includes at least one memory coupled to the one or more computer processors.

In another aspect, a method of dynamically adjusting buffer size and transmitting data includes determining a backhaul round trip time delay (T1), and determining a WiFi rate. The method additionally includes determining whether a size of a transmitter apparatus buffer is less than a threshold determined based at least on T1 and the WiFi rate. The method also includes increasing the size of the transmitter apparatus buffer when the size of the transmitter apparatus buffer is less than the threshold. The method further includes transmitting data of the transmitter apparatus buffer.

In another aspect, a transmitter apparatus includes means for determining a backhaul round trip time delay (T1), and means for determining a WiFi rate. The transmitter apparatus additionally includes means for determining whether a size of a transmitter apparatus buffer is less than a threshold determined based at least on T1 and the WiFi rate. The transmitter apparatus also includes means for increasing the size of the transmitter apparatus buffer when the size of the transmitter apparatus buffer is less than the threshold. The transmitter apparatus further includes means for transmitting data of the transmitter apparatus buffer.

In another aspect, a computer program product comprising a non-transitory computer-readable medium having instructions recorded thereon that, when enacted by one or more computer processors, cause the one or more computer processors to carry out operations. For example, the operations include determining a backhaul round trip time delay (T1). The operations also include determining a WiFi rate, and determining whether a size of a transmitter apparatus buffer is less than a threshold determined based at least on T1 and the WiFi rate. The operations further include increasing the size of the transmitter apparatus buffer when the size of the transmitter apparatus buffer is less than the threshold, and transmitting data of the transmitter apparatus buffer.

In another aspect, a transmitter apparatus includes one or more computer processors configured to determine a backhaul round trip time delay (T1) and determine a WiFi rate. The one or more computer processors are also configured to determine whether a size of a transmitter apparatus buffer is less than a threshold determined based at least on T1 and the WiFi rate. The one or more computer processors are further configured to increase the size of the transmitter apparatus buffer when the size of the transmitter apparatus buffer is less than the threshold. The one or more computer processors are further configured to transmit data of the transmitter apparatus buffer. The transmitter apparatus also includes at least one memory coupled to the one or more computer processors.

Various aspects and features of the disclosure are described in further detail below.

### BRIEF DESCRIPTION OF THE DRAWINGS

FIG. 1 is a block diagram illustrating an example of a telecommunications system;

FIG. 2 is a block diagram illustrating an example of a down link frame structure in a telecommunications system;

FIG. 3 is a block diagram illustrating a design of an eNodeB and a UE configured according to one aspect of the present disclosure;

FIG. 4 is a block diagram illustrating an example of transmission of scheduled data over multiple links;

FIG. 5 is a block diagram illustrating example blocks of a first process of scheduling and transmitting data over multiple links;

FIG. 6A is a block diagram illustrating example blocks of a second process of scheduling and transmitting data over multiple links;

FIG. 6B is a graphical representation presenting an example of data scheduled according to the second process of FIG. 6A;

FIG. 6C is a graphical representation presenting an example data scheduling technique according to the second process of FIG. 6A and the example of FIG. 6B;

FIG. 7 is a block diagram illustrating example blocks of a third process of scheduling and transmitting data over multiple links;

FIG. 8 is a block diagram illustrating example blocks of a fourth process of scheduling and transmitting data over multiple links;

FIG. 9 is a block diagram illustrating example blocks of a fifth process of scheduling and transmitting data over multiple links;

FIG. 10 is a block diagram illustrating example blocks of a method of manufacturing a transmitter apparatus; and

FIG. 11 is a block diagram illustrating example blocks of a process of dynamically adjusting buffer size and transmitting data.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

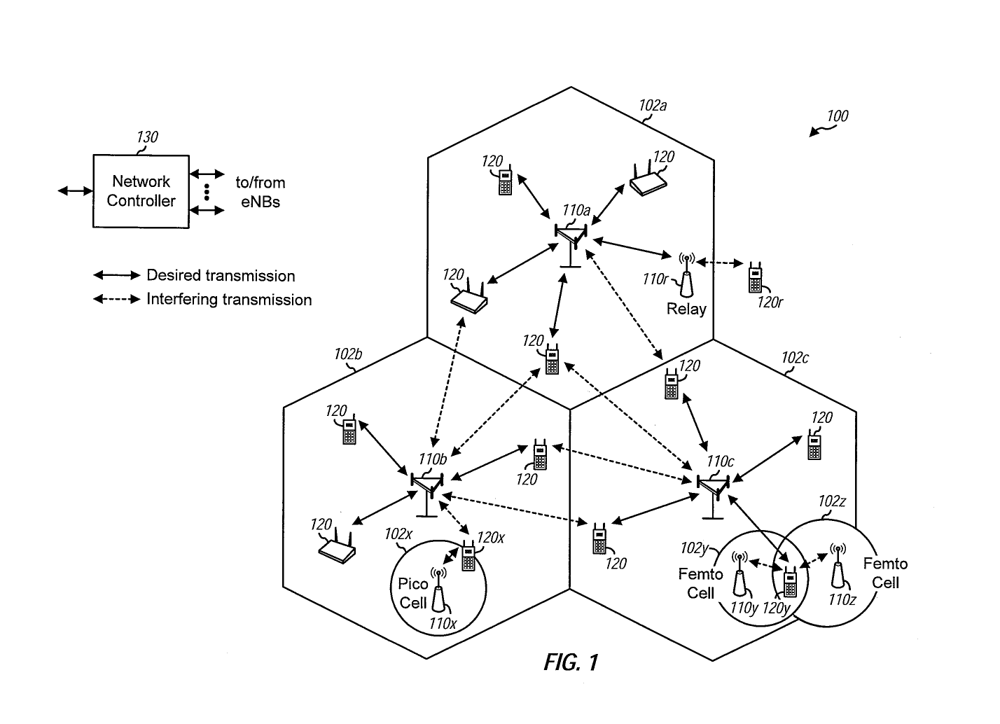

FIG. 1 shows a wireless communication network 100, which may be an LTE network. The wireless network 100 may include a number of evolved Node Bs (eNodeBs) 110 and other network entities. An eNodeB may be a station that communicates with the UEs and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB and/or an eNodeB subsystem serving this coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x serving a UE 120x. The eNodeBs 110y and 110z may be femto eNodeBs for the femto cells 102y and 102z, respectively. An eNodeB may support one or multiple (e.g., three) cells.

The wireless network 100 may also include relay stations. A relay station is a station that receives a transmission of data and/or other information from an upstream station (e.g., an eNodeB or a UE) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a smart phone, a handheld device, a laptop computer, a tablet, a cordless phone, a wireless local loop (WLL) station, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

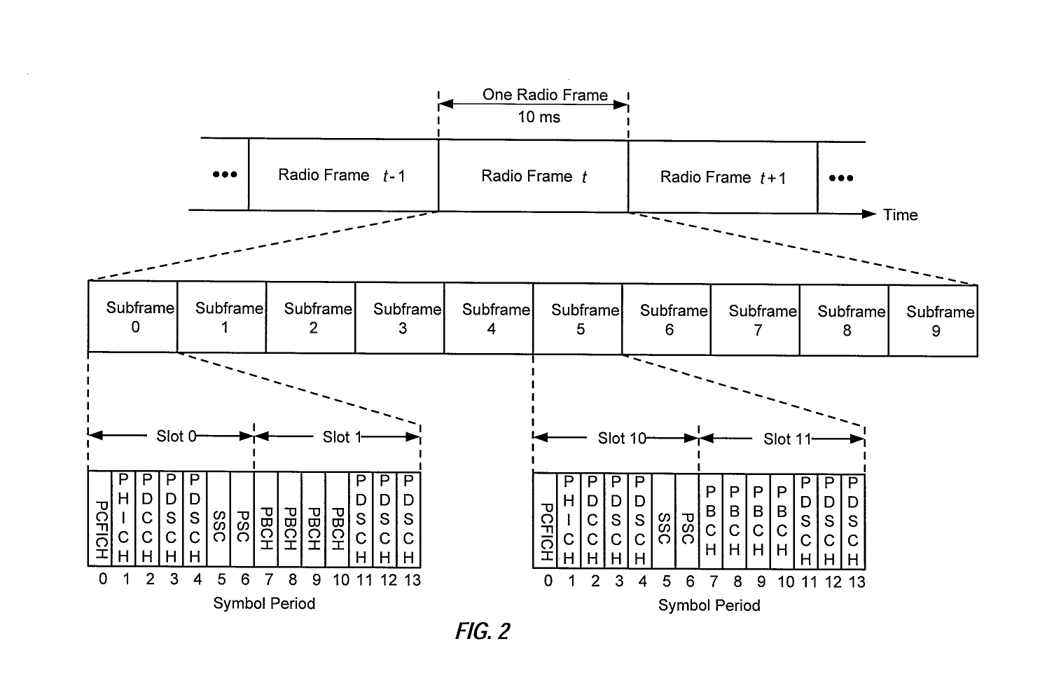

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not. shown that way in FIG. 2. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

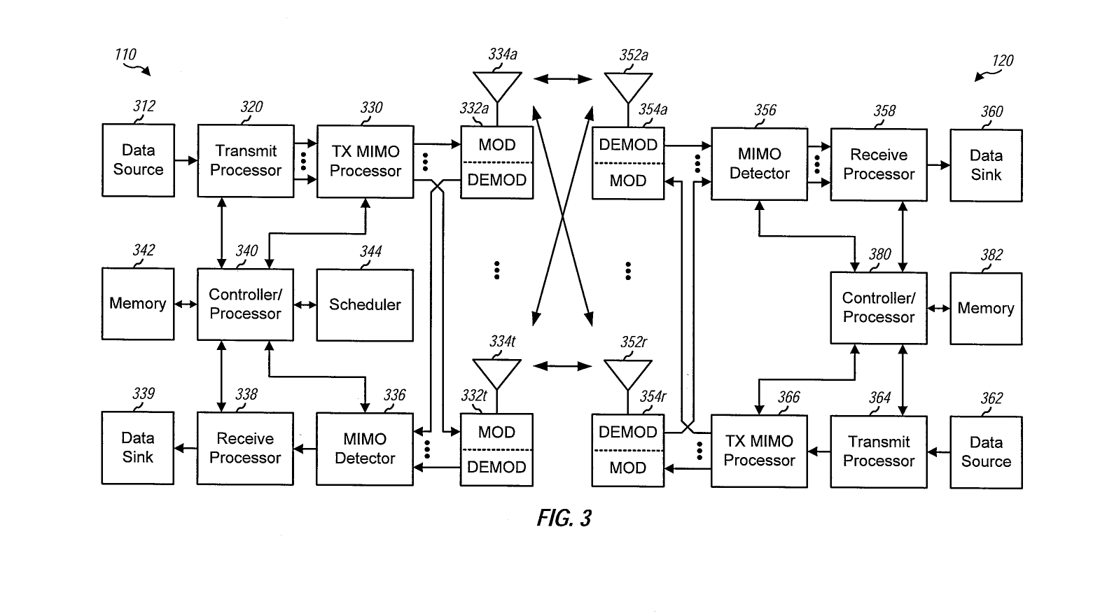

FIG. 3 shows a block diagram of a design of an eNodeB 110 and a UE 120, which may be one of the eNodeBs and one of the UEs in FIG. 1. For a restricted association scenario, the eNodeB 110 may be the macro eNodeB 110c in FIG. 1, and the UE 120 may be the UE 120y. The eNodeB 110 may be equipped with antennas 334a through 334t, and the UE 120 may be equipped with antennas 352a through 352r.

At the eNodeB 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the eNodeB 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a transmit MIMO processor 366 if applicable, further processed by the modulators 354a through 354r (e.g., for SC-FDM, etc.), and transmitted to the eNodeB 110. At the eNodeB 110, the uplink signals from the UE 120 may be received by the antennas 334, processed by the demodulators 332a through 332t, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

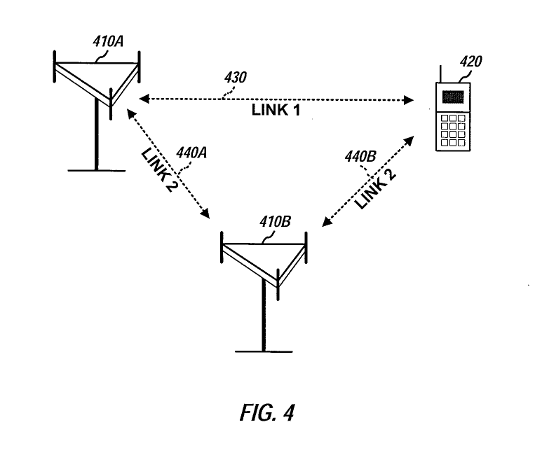

The controllers/processors 340 and 380 may direct the operation at the eNodeB 110 and the UE 120, respectively. The processor 340 and/or other processors and modules at the eNodeB 110 may perform or direct the execution of various processes for the techniques described herein. The processor 380 and/or other processors and modules at the UE 120 may also perform or direct the execution of the functional blocks illustrated in FIGS. 4-8, and/or other processes for the techniques described herein. The memories 342 and 382 may store data and program codes for the eNodeB 110 and the UE 120, respectively. A scheduler 344 may schedule UEs for data transmission on the downlink and/or uplink.

As mentioned above, features like dual connectivity and 3GPP Long Term Evolution (LTE) Wireless Local Area Network (WLAN) Packet Data Convergence Protocol (PDCP) aggregation distribute traffic over multiple links. The delay of each link may be different, resulting in out of sequence arrival of packets at the receiver side. The delivered packets may be reordered at the receiver side. However, significant difference in link delay may result in receiver side reordering timeout and high usage of memory and central processing unit (CPU) resources.

FIG. 4 shows an example of transmission of scheduled data over multiple links. For example, an LTE eNodeB 410 may transmit data to a UE 420 over a first link 430 and a second link 440A and 440B. The first link 430 may be a direct link to the UE, whereas the second link may be an indirect link that passes through an IEEE 802.11x. (WiFi) access point 410B. These two different links may experience different delay, but the LTE eNB may be implemented to avoid or reduce out of sequence delivery of data to the UE by implementing techniques disclosed herein. It is envisioned that there may be more than two links, and that the techniques described below may be applied to any number of two or more links. As further explained below, other types of transmitter apparatuses may implement one or more of these techniques to avoid or reduce out of sequence delivery of data. Stated differently, the techniques disclosed herein are not limited to wireless networks, but can also be applied to Multi-path TCP or application layers that distribute data over different paths to a receiver. Also, a path or link may be wireless, wired, or combined.

It should be appreciated that eNodeB 410 may be an example of eNodeB 110, as described above. It should also be appreciated that UE 420 may be an example of UE 120, as described above. Furthermore, it is envisioned that UE 420 may have its own scheduler and be capable of scheduling traffic for transmission over multiple links on the uplink. Accordingly, it is envisioned that techniques described herein may be implemented at eNodeB 410 or another type of base station, and/or at UE 420.

In some cases, the transmitter may know a particular link/path has lower latency than the other one, and may also know the delay difference of the links. For example, in the LTE Dual-connectivity (DC) feature, the Master cell group (MCG) usually has lower latency than the Secondary cell group (SCG) because the data flow is MCG<->SCG<->UE or MCG<->UE. In this scenario, the delay difference is mainly due to the MCG<-->SCG backhaul delay. Additionally, in the LTE-WLAN PDCP aggregation feature, the LTE usually has lower latency than the WLAN because the data flow is eNB<->WLAN AP<->UE or eNB<->UE. In this scenario, the delay difference is mainly due to the eNB<-->WLAN AP backhaul delay. Also, in Multi-path TCP, there are multiple connections (each with different IP address pairs), and one connection may have lower delay than other connections. In this scenario, the delay difference can be obtained based on round-trip time measurement and estimation at the transmitter side.

In some cases, such as for dual-connectivity (DC) feature, a queuing delay for the data flow among MCG, SCG and UE, and a queuing delay for the data flow between MCG and UE may be also measured. The queuing delay may be equal to a time duration of data/packets waiting in queue before transmission. Therefore, the link delay time may include the time that the packet waits in the transmission queue and the time that the packet is transmitted from a transmitter, such as the MCG, to a receiver, such as the UE. Accordingly, the delay of the link “MCG<->SCG<->UE” may be the duration from the time a packet is submitted to the MCG transmission queue for the link “MCG<->SCG<->UE” to the time the packet is received at the UE. The delay of the link “MCG<->UE” may be the duration from the time a packet is submitted to the MCG transmission queue for the link “MCG<->UE” to the time the packet is received at the UE. In this scenario, the delay difference between the two links may be due to the MCG<-->SCG backhaul delay and the queuing delay difference of the two links.

In some cases, such as for multi-path transmission control protocol (TCP), the round-trip time of a link may include the queuing delay at the transmitter and intermediate nodes, and the time that the packet is moved from the transmitter to the receiver and the time the packet is moved from the receiver to the transmitter.

In some cases, the delay difference between the two links can be estimated by the receiver (e.g., UE) of the two links and reported by the receiver to the transmitter (e.g., MCG eNB).

In some cases, the delay difference between the two links can be estimated by the transmitter that has access to both links (e.g., MCG eNB).

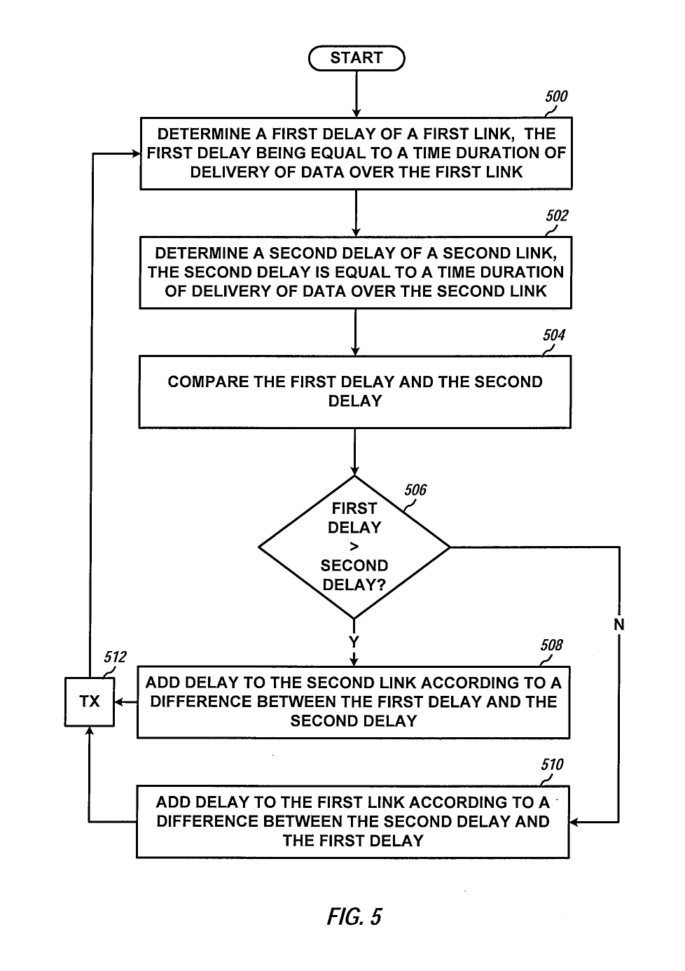

FIG. 5 shows example blocks of a first process of scheduling and transmitting data over multiple links. This process effectively adds extra delay at the lower delay link or links to avoid or reduce out of sequence delivery of data over the multiple links. It is envisioned that this process may be performed by a scheduler or TCP layer of a transmitter apparatus, such as a base station, a UE, a combination of a network controller and one of a base station or UE, or a wired transmitter, to render the delay in all links as equal as possible. It is also envisioned that this process may require additional buffer size at the transmitter. Although the process is described below for two links, it is envisioned that any number of two or more links may be employed. In the case of three or more links, the transmitter apparatus may add delay to all links other than the link having the longest delay. For example, if link 1/2/3 delay=d1, d2, d3, and d1<d2<d3, then the transmitter apparatus may add (d3−d1) to link1 and (d3−d2) to link2.

Beginning at block 500, a transmitter apparatus may determine a first delay of a first link. It is envisioned that the first delay may be determined by measuring backhaul delay relating to the first link. Alternatively or additionally, it is envisioned that the first delay may be determined based on a round trip time relating to the first link. Processing may proceed from block 500 to block 502. In some cases, a first queuing delay of the first link and a second queuing delay of the second link may be also determined.

At block 502, the transmitter apparatus may determine a second delay of a second link. It is envisioned that the second delay may be determined by measuring backhaul delay relating to the second link. Alternatively or additionally, it is envisioned that the second delay may be determined based on a round trip time relating to the second link. Processing may proceed from block 502 to block 504.

At block 504, the transmitter apparatus may determine a difference between the first delay of the first link and the second delay of the second link. It is envisioned that the difference may be determined by comparing the first delay and the second delay. Alternatively or additionally, it is envisioned that the difference may be determined based on a backhaul delay relating to the first link and the second link and/or based on a round trip time relating to the first link and the second link. Processing may proceed from block 504 to block 506.

At block 506, the transmitter apparatus may determine whether the first delay is larger than the second delay. It is envisioned that the transmitter apparatus may, at block 506, evaluate whether results of a comparison performed at block 504 are greater or less than zero. Alternatively or additionally, it is envisioned that the transmitter apparatus may, at block 506, evaluate a direction of a backhaul delay. If it is determined, at block 506, that the first delay is larger than the second delay, then processing may proceed from block 506 to block 508. However, if it is determined, at block 506, that the first delay is not larger than the second delay, or that the second delay is larger than the first delay, then processing may proceed from block 506 to block 510.

At block 508, the transmitter apparatus may add delay to the second link. For example, the transmitter apparatus may schedule data for transmission over the second link at a later time, as opposed to transmitting data over the second link in sequence with transmission of data over the first link. It is envisioned that, at block 508, the transmitter apparatus may add delay to the second link based on the difference between the first delay and the second delay. For example, the transmitter apparatus may add delay to the second link that is equal to an absolute value of the difference between the first delay and the second delay. Processing may proceed from block 508 to block 512.

In some cases, the first delay may include a time duration of the data waiting in a first transmission queue and a time duration of the data being transmitted to a receiver over the first link. The second delay may include a time duration of the data waiting in a second transmission queue and a time duration of the data being transmitted to the receiver over the second link. For example, the transmitter apparatus may add delay to the second link that is equal to an absolute value of the difference between a time duration of the data waiting in a first transmission queue and a time duration of the data waiting in a second transmission queue, and an absolute value of the difference between a time duration of the data being transmitted to a receiver over the first link and a time duration of the data being transmitted to the receiver over the second link. The time duration of the data waiting in the first or second transmission queue (e.g., the first or second queuing delay) may include a time duration of the data waiting in a source transmitter and/or one or more intermediate nodes.

At block 510, the transmitter apparatus may add delay to the first link. For example, the transmitter apparatus may schedule data for transmission over the first link at a later time, as opposed to transmitting data over the first link in sequence with transmission of data over the second link. It is envisioned that, at block 508, the transmitter apparatus may add delay to the first link based on the difference between the first delay and the second delay. For example, the transmitter apparatus may add delay to the first link that is equal to an absolute value of the difference between the first delay and the second delay. Processing may proceed from block 510 to block 512.

In some cases, the first delay may include a time duration of the data waiting in a first transmission queue and a time duration of the data being transmitted to a receiver over the first link. The second delay may include a time duration of the data waiting in a second transmission queue and a time duration of the data being transmitted to the receiver over the second link. For example, the transmitter apparatus may add delay to the first link that is equal to an absolute value of the difference between a time duration of the data waiting in a first transmission queue and a time duration of the data waiting in a second transmission queue, and an absolute value of the difference between a time duration of the data being transmitted to a receiver over the first link and a time duration of the data being transmitted to the receiver over the second link. The time duration of the data waiting in the first or second transmission queue (e.g., the first or second queuing delay) may include a time duration of the data waiting in a source transmitter and/or one or more intermediate nodes.

At block 512, the transmitter apparatus may transmit data over the first link and the second link. For example, the transmitter apparatus may transmit data, when the first delay is larger than the second delay, over the first link and the second link according to the delay added to the second link. Also, the transmitter apparatus may transmit data, when the second delay is larger than the first delay, over the first link and the second link according to the delay added to the first link. Processing may return from block 512 to block 500.

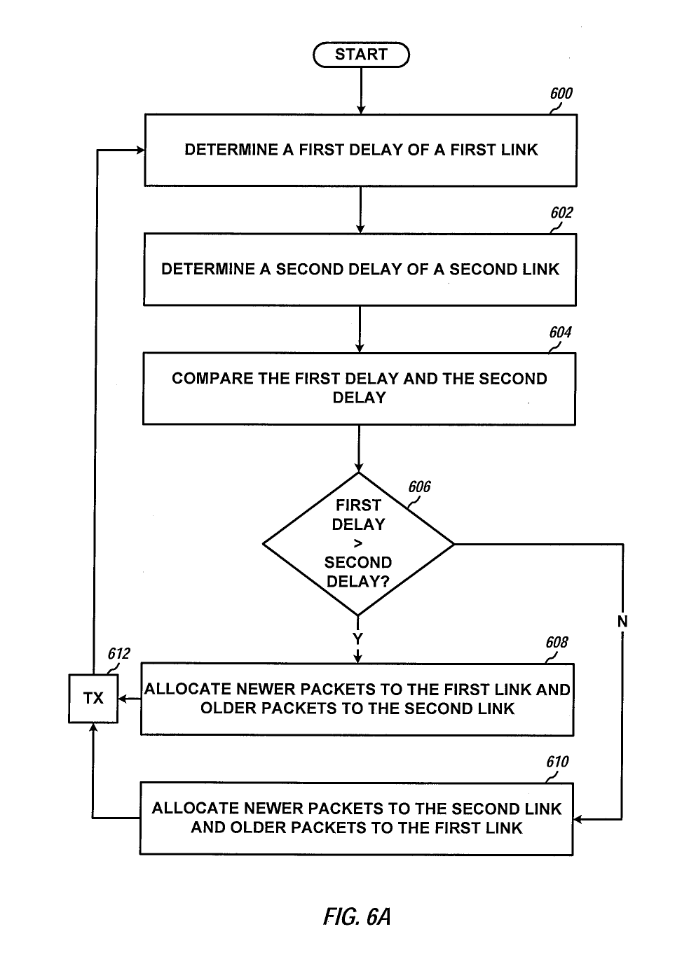

FIG. 6 shows example blocks of a second process of scheduling and transmitting data over multiple links. This process effectively allocates new packets to a long-delay link and older packets to a low-delay link. This process may be implemented by a scheduler of a transmitter apparatus, such as a base station, a UE, a combination of a network controller and one of a base station or UE, or a wired transmitter, to ensure that data received at a receiver in each operation time unit (TTI in LTE) is in sequence. However, when it is not possible to avoid out of order delivery of data, then the process may be implemented to minimize or reduce the number of out-of-order packets. Whereas this process may require a more complicated logic than that of the process described above with reference to FIG. 5, it may advantageously avoid the requirement for a larger buffer size at the transmitter. Although the process is described below for two links, it is envisioned that any number of two or more links may be employed. In the case of three or more links, the transmitter apparatus may distribute the traffic across the links to decrease or eliminate out of sequence delivery. For example, if link 1/2/3 delay=d1, d2, d3, and d1<d2<d3; assuming the transmitter has packet #1, #2, #3 (#1 arrived first at the transmitter—oldest packet; #2 arrived second; #3 arrived third—newest); then the transmitter may send packet #1 over link1, packet #2 over link2 and packet #3 over link3.

Beginning at block 600, a transmitter apparatus may determine a first delay of a first link. It is envisioned that the first delay may be determined by measuring backhaul delay relating to the first link. Alternatively or additionally, it is envisioned that the first delay may be determined based on a round trip time relating to the first link. Processing may proceed from block 600 to block 602.

At block 602, the transmitter apparatus may determine a second delay of a second link. It is envisioned that the second delay may be determined by measuring backhaul delay relating to the second link. Alternatively or additionally, it is envisioned that the second delay may be determined based on a round trip time relating to the second link. Processing may proceed from block 602 to block 604.

At block 604, the transmitter apparatus may determine a difference between the first delay of the first link and the second delay of the second link. It is envisioned that the difference may be determined by comparing the first delay and the second delay. Alternatively or additionally, it is envisioned that the difference may be determined based on a backhaul delay relating to the first link and the second link and/or based on a round trip time relating to the first link and the second link. Processing may proceed from block 604 to block 606.

At block 606, the transmitter apparatus may determine whether the first delay is larger than the second delay. It is envisioned that the transmitter apparatus may, at block 606, evaluate whether results of a comparison performed at block 604 are greater or less than zero. Alternatively or additionally, it is envisioned that the transmitter apparatus may, at block 606, evaluate a direction of a backhaul delay. If it is determined, at block 606, that the first delay is larger than the second delay, then processing may proceed from block 606 to block 608. However, if it is determined, at block 606, that the first delay is not larger than the second delay, or that the second delay is larger than the first delay, then processing may proceed from block 606 to block 610.

At block 608, the transmitter apparatus may allocate newer packets to the first link and older packets to the second link. Thus, the transmitter apparatus allocates newer packets to the first link and older packets to the second link when the first delay is larger than the second delay. For example, at block 608, the scheduler of the transmitter apparatus may allocate, to the first link, packets that arrived at the transmitter earlier than packets allocated to the second link. Alternatively, at block 608, the scheduler of the transmitter apparatus may allocate, to the first link, packets that have higher sequence numbers than packets allocated to the second link. Thus, allocating newer packets may be performed according to order of packet arrival at a transmitter or according to packet sequence number. It is also envisioned that, at block 608, allocating newer packets to the first link and older packets to the second link may be performed according to the difference between the first delay and the second delay. Processing may proceed from block 608 to block 612.

At block 610, the transmitter apparatus may allocate newer packets to the second link and older packets to the first link. Thus, the transmitter apparatus allocates newer packets to the second link and older packets to the first link when the second delay is larger than the first delay. For example, at block 610, the scheduler of the transmitter apparatus may allocate, to the second link, packets that arrived at the transmitter earlier than packets allocated to the first link. Alternatively, at block 608, the scheduler of the transmitter apparatus may allocate, to the second link, packets that have higher sequence numbers than packets allocated to the first link. Thus, allocating newer packets may be performed according to order of packet arrival at a transmitter or packet sequence number. It is also envisioned that, at block 610, allocating newer packets to the second link and older packets to the first link may be performed according to the difference between the second delay and the first delay. Processing may proceed from block 610 to block 612.

At block 612, the transmitter apparatus may transmit the allocated packets over the first link and the second link. For example, the transmitter apparatus may transmit the allocated newer packets over the first link and the allocated older packets over the second link when the first delay is larger than the second delay. Also, the transmitter apparatus may transmit the allocated newer packets over the second link and the allocated older packets over the first link when the second delay is larger than the first delay. Processing may return from block 612 to block 600.

FIG. 6B presents an example of data scheduled according to the second process of FIG. 6A. This example considers the downlink traffic in the DC feature where the traffic of a bearer is split over two links. This example also assumes a one-way link delay for SCG is four milliseconds, and the one-way link delay for MCG is zero milliseconds. The goal, in this example, is to ensure that data received at the receiver in each millisecond is in sequence. A result of successful receipt of data in sequence over multiple links is shown at 614. The packet numbers may be filled into a suitable data structure in sequence as shown at 614. Then, upon deriving when the filled packets should be transmitted, the filled data for the SCG link may be shifted by four milliseconds, which is the SCG link delay. The filled data for the MCG link may be shifted by zero milliseconds, which is the MCG link delay. Stated differently, the filled data for the long-delay link may be shifted according to the difference in delay between the links. The shifted data, which is out of sequence data, may then be transmitted by the transmitter apparatus to achieve in sequence arrival of the data over the multiple links at the receiver.

FIG. 6C presents an example data scheduling technique according to the second process of FIG. 6A and the example of FIG. 6B. In this example, which is generalized based on the example of FIG. 6B, a scheduling epoch is a time for transmission of one or multiple data bursts. Additionally, time=0 at the start time of a scheduling epoch. This example also employs an absolute value of a maximum delay difference (dt) between the first link and the second link, with dt being in a unit of unit scheduling time (UST). This example further employs an average link throughput or data rate of the second link (R1), and an average link throughput or data rate of the first link (R2). Scalar values a and b_n may be employed to govern partitioning of data, for example, when it is not possible to achieve in sequence arrival of data.

The data scheduling process of FIG. 6C may start with ordering of unscheduled data according to packet arrival time or packet sequence numbers. Then, for each scheduling epoch the following operations may be performed:
(a) allocate a first (dt*R1*a) amount of data from an entire data queue to the second link;
(b) partition a remaining amount of the data into block #1, 2, . . . , n, . . . ; wherein data block n contains (R1+R2)*UST*b_n amount of data; and
(c) partition each data block into two parts under the following constraints, and assign the partitioned data blocks to the links:
   (1) second link data size is less than or equal to R1*UST;
   (2) first link data size is less than or equal to R2*UST;
   (3) for data block n, data allocated to the second link is sent at time=(dt+n)*UST; and
   (4) for data block n: data allocated to the first link is sent at time=n*UST.

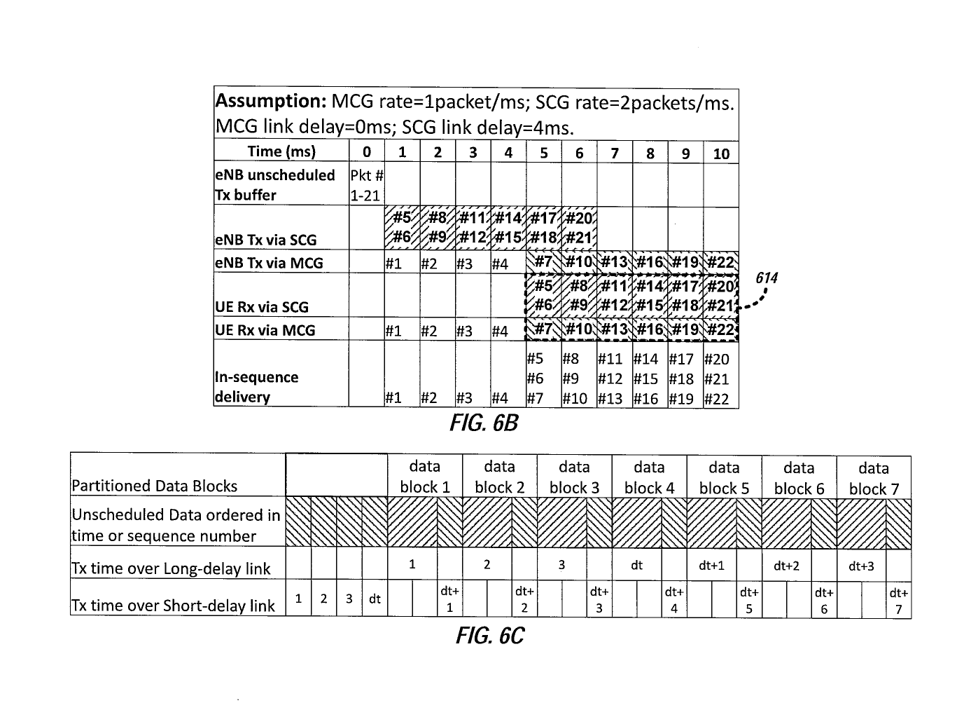

FIG. 7 shows example blocks of a third process of scheduling and transmitting data over multiple links. A transmitter apparatus, such as a base station, a UE, a combination of a network controller and one of a base station or UE, or a wired transmitter, employing this process effectively disables multi-link under low throughput conditions, and thus avoids out of sequence delivery at the receiver under low throughput conditions. This process also reduces delay under low throughput conditions because it eliminates the need for packet reordering at the receiver under low throughput conditions. Although the process is described below for two links, it is envisioned that any number of two or more links may be employed. In the case of three or more links, the transmitter apparatus may monitor any or all of the links, determine thresholds for any or all of the links, and distribute traffic to any one of the links under low throughput conditions.

Beginning at block 700, the transmitter apparatus may determine average link data rate, link throughputs, and/or delay of a first link and/or a second link. It is envisioned that, at block 700, delay may be determined by measuring backhaul delay relating to the first link and/or the second link. Alternatively or additionally, it is envisioned that delay may be determined based on a round trip time relating to the first link and/or the second link. It is also envisioned that parameters, such as average link data rate, link throughputs, and/or delay, may be measured or determined for each of the first link and the second link. Processing may proceed from block 700 to block 702.

At block 702, the transmitter apparatus may determine a threshold based on the average link data rate, the link throughputs, and/or the delay. For example, the transmitter apparatus may determine the threshold to be a given percentage, such as fifty percent, of a recent average link data rate for one of the first link or the second link. The given percentage may be any percentage less than one-hundred percent and greater than a negligible rate. It is also envisioned that, at block 702, individual thresholds may be determined for each of the first link and the second link. Processing may proceed from block 702 to block 704.

At block 704, the transmitter apparatus may determine a traffic arrival rate at the transmitter. Processing may proceed from block 704 to block 706.

At block 706, the transmitter apparatus may compare the traffic arrival rate to the threshold or thresholds determined at block 702. If it is determined, at block 706, that the traffic arrival rate is greater than the threshold or thresholds, then processing may proceed from block 706 to block 708. However, if it is determined, at block 706, that the traffic arrival rate is less than the threshold or at least one of the thresholds, then processing may proceed from block 706 to block 710. Alternatively or additionally, the transmitter apparatus may, at block 706, determine whether the traffic arrival rate is less than a threshold determined for a link having a highest signal quality, and proceed to block 710 in response to this determination, proceeding otherwise to block 708.

At block 708, the transmitter apparatus may distribute traffic to both the first link and the second link. Thus, the transmitter apparatus may distribute traffic to both the first link and the second link when the traffic arrival rate is greater than the threshold. Processing may proceed from block 708 to block 712.

At block 710, the transmitter apparatus may distribute traffic to only one of the first link or the second link. Thus, the transmitter apparatus may distribute traffic to only one of the first link and the second link when the traffic arrival rate is less than the threshold. It is envisioned that the transmitter apparatus may distribute traffic only to the link having the average link data rate with respect to which the threshold was determined. Alternatively or additionally, it is envisioned that the transmitter apparatus may distribute traffic only to the link having the highest signal quality.

At block 712, the transmitter apparatus may transmit the distributed traffic over at least one of the first link or the second link. For example, if the traffic is distributed over the first link and the second link, then the transmitter apparatus may transmit the traffic over the first link and the second link. If, however, the traffic is distributed over only one of the links, then the transmitter apparatus may transmit the traffic over only the link over which the traffic is distributed. Processing may return from block 712 to block 700.

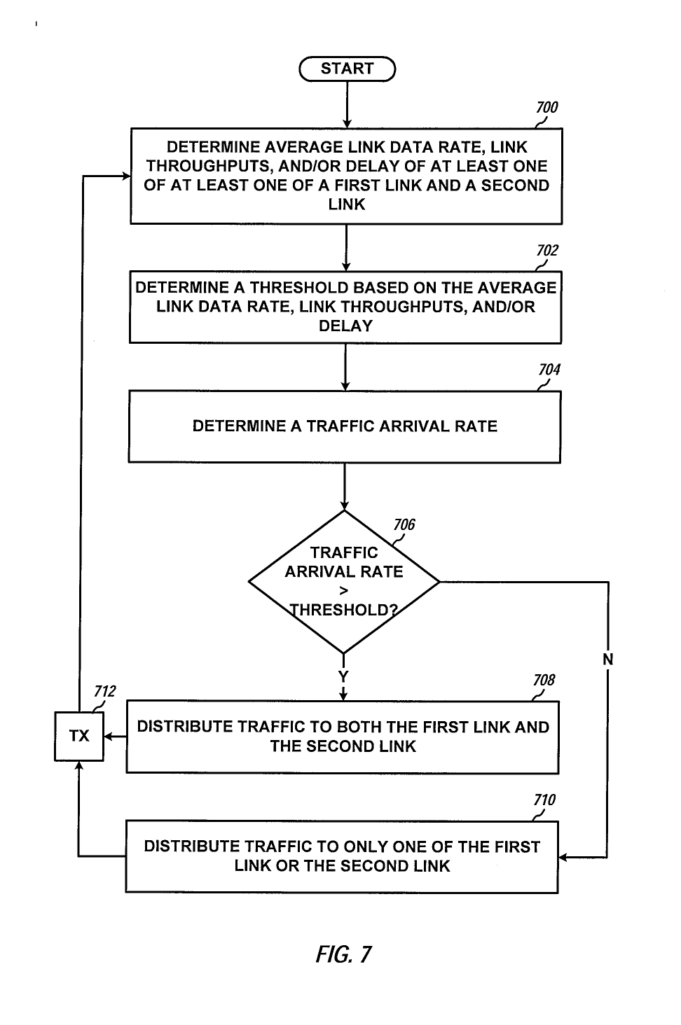

FIG. 8 shows example blocks of a fourth process of scheduling and transmitting data over a link of multiple links. A transmitter apparatus, such as a base station, a UE, a combination of a network controller and one of a base station or UE, or a wired transmitter, implementing this technique may effectively avoid overflow using history information. With this technique, the transmitter apparatus may distribute data to a link such that transmission buffer occupancy of the link is lower than or equal to a given limit. It is envisioned that this process may be performed for each link of multiple links, such that data is distributed to each link such that transmission buffer occupancy of each link is lower than or equal to a given limit for the respective link.

Beginning at block 800, the transmitter apparatus may determine a total size of data sent over the link during one or more previous unit scheduling times (Spast). It is envisioned that the processing performed at block 800 may be performed individually for multiple links, wherein each link may have its own start time (T0) for a scheduling epoch and its own unit scheduling time (UST). It is also envisioned that Spast may be determined according to:

Spast=total data size that was sent in the past (T0−1)*UST time.

Processing may proceed from block 800 to block 802.

At block 802, the transmitter apparatus may compare the total size of data sent over the link during the previous unit scheduling time Spast to a threshold maximum amount of data (Smax). It is envisioned that the processing performed at block 802 may be performed individually for multiple links, wherein each link may have its own Spast and its own Smax. It is also envisioned that Smax may be determined according to:

Smax=(T0+delta)*UST*recent link average throughput,

wherein delta is a percentage, such as thirty percent, of T0. It is envisioned that delta may be any percentage less than one-hundred percent, and greater than a negligible amount. Processing may proceed from block 802 to block 804.

At block 804, the transmitter apparatus may, during a current unit scheduling time, distribute an amount of traffic to the link that is less than or equal to Smax−Spast amount of data. It is envisioned that processing performed at block 804 may be performed individually for multiple links, wherein each link may have its own Spast and its own Smax. Processing may proceed from block 804 to block 806.

At block 806, the transmitter apparatus may transmit the distributed data over the link. It is envisioned that processing performed at block 806 may be performed individually for multiple links, wherein each link may have its own distributed data. Processing may return from block 806 to block 800.

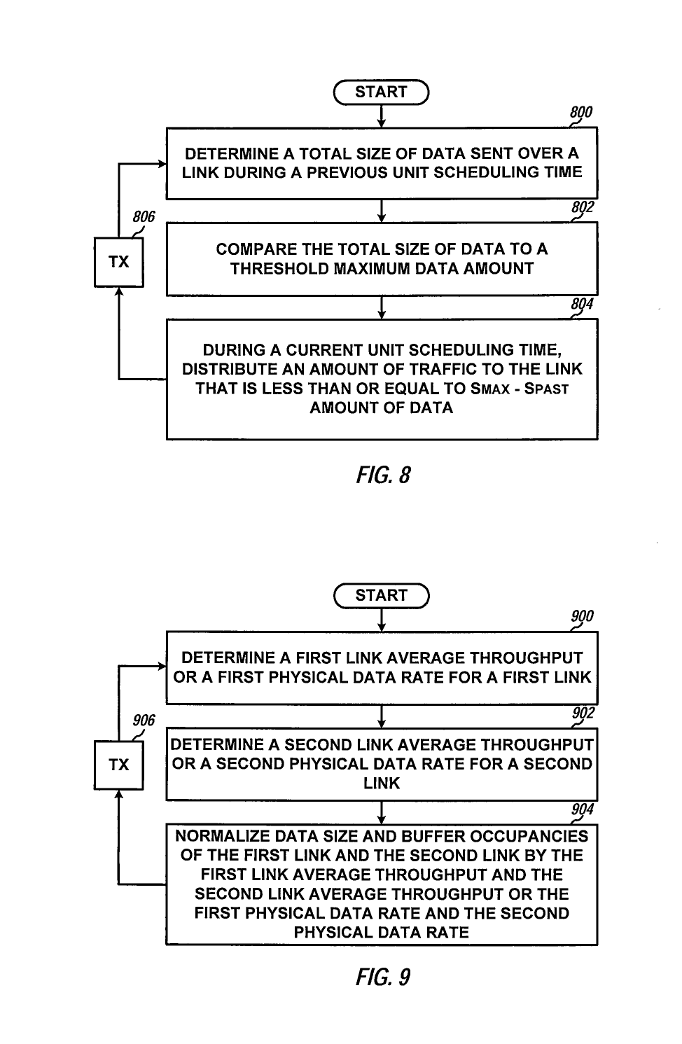

FIG. 9 shows example blocks of a fifth process of scheduling and transmitting data over multiple links. A transmitter apparatus, such as a base station, a UE, a combination of a network controller and one of a base station or UE, or a wired transmitter, implementing this technique may effectively avoid overflow by normalizing data size into time. To remove link rate imbalance, the scheduler may normalize/divide the data size and the buffer occupancies of all links by the corresponding link average throughputs or the physical data rates. Although the process is described below for two links, it is envisioned that any number of two or more links may be employed. In the case of three or more links, the transmitter apparatus may normalize distribution of traffic over all of the links according to the respective link capacities.

Beginning at block 900, the transmitter apparatus may determine a first link average throughput and/or a first physical data rate of a first link. Processing may proceed from block 900 to block 902.

At block 902, the transmitter apparatus may determine a second link average throughput and/or a second physical data rate of a second link. Processing may proceed from block 902 to block 904.

At block 904, the transmitter apparatus may normalize data size and buffer occupancies of the first link and the second link by the first link average throughput and the second link average throughput, or by the first physical data rate and the second physical data rate. For example, given a total amount of data that needs to be transmitted (Total_Data_Size), and given that the data size allocated to the second link (L2_Data_Size) should be equal to the difference between the Total_Data_Size and the data size allocated to the first link (L1_Data_Size), then L1_Data_Size may be determined from the first link average throughput or the first physical data rate (L1_Capacity) and the second link average throughput or the second physical data rate (L2_Capacity) as follows:

L1_Data_Size/L1_Capacity=(Total_Data_Size−L1_Data_Size)/L2_Capacity.

Solving for L1_Data_Size yields:

L1_Data_Size=Total_Data_Size/(1+(L2_Capacity/L1_Capacity)).

Once the L1_Data_Size is determined from the Total_Data_Size and the determined link capacities, the L2_Data_Size may be determined as follows:

L2_Data_Size=Total_Data_Size−L1_Data_Size.

Accordingly, the transmitter device may, at block 904, allocate data to the links according to the determined data sizes for the respective links. Processing may proceed from block 904 to block 906.

At block 906, the transmitter device may transmit the allocated data over the first link and the second link. Processing may return from block 906 to block 900.

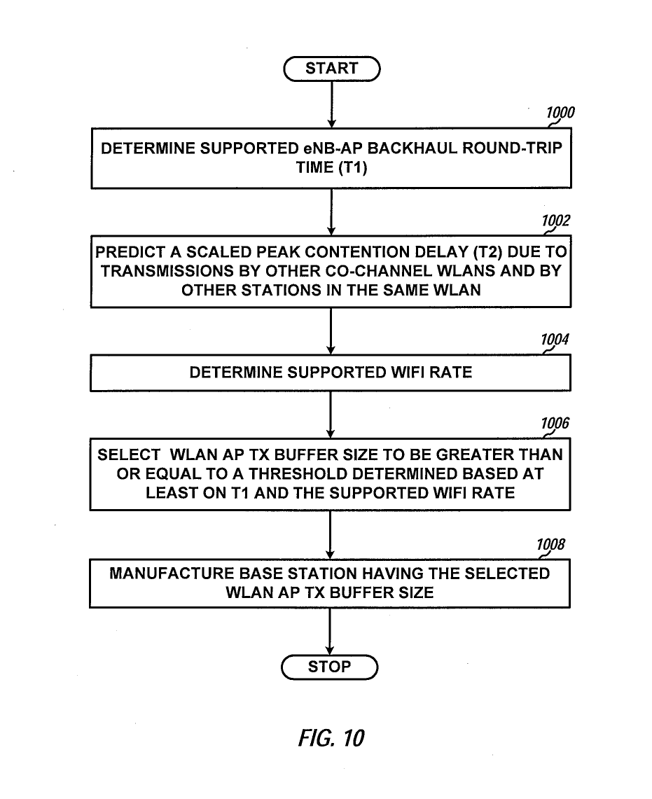

FIG. 10 shows example blocks of a method of manufacturing a transmitter apparatus, such as a WLAN access point, an eNB, and/or a wired transmitter. Beginning at block 1000, a determination is made regarding a supported backhaul round trip time (T1). The method may proceed from block 1000 to block 1002.

At block 1002, for a transmitter apparatus corresponding to a WLAN access point, a prediction may be made regarding a scaled peak contention delay (T2) due to transmissions by co-channel wireless nodes and by other wireless nodes in a same WLAN. It is envisioned that the scaled contention delay (T2) may be scaled to three times a predicted contention delay, but other scalar values are also contemplated. The method may proceed from block 1002 to block 1004.

At block 1004, a determination is made regarding a highest supported WiFi rate. The method may proceed from block 1004 to block 1006.

At block 1006, a buffer size of the transmitter apparatus may be selected based at least on T1 and the supported WiFi rate. For example, for an eNB or wired transmitter, the buffer size may be selected to be greater than or equal to (T1*supported WiFi rate). Alternatively, for a WLAN access point, the WLAN access point (AP) transmission (TX) buffer size may be selected to be greater than or equal to (MAX(T1,T2)*supported WiFi rate). The method may proceed from block 1006 to block 1008.

At block 1008, the transmitter apparatus may be manufactured to have the selected buffer size. After block 1008, the method may end.

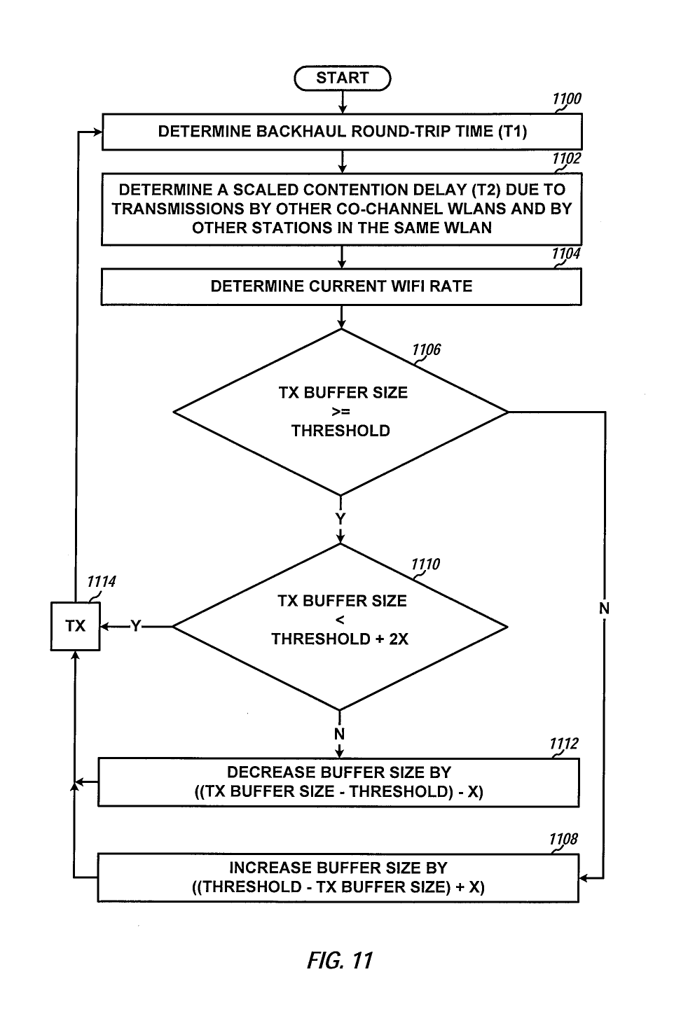

FIG. 11 shows example blocks of a process of dynamically adjusting buffer size and transmitting data. Beginning at block 1100, the transmitter apparatus, such as a WLAN access point, an eNB, and/or a wired transmitter, may determine a backhaul round trip time delay (T1). Processing may proceed from block 1100 to block 1102.

At block 1102, for a transmitter apparatus corresponding to a WLAN access point, the transmitter apparatus may determine a scaled contention delay (T2) due to transmissions by co-channel wireless nodes and by other wireless nodes in a same wireless local area network (WLAN). It is envisioned that the scaled contention delay (T2) may be scaled to three times a measured, reported, or estimated contention delay, but other scalar values are also contemplated. Processing may proceed from block 1102 to block 1104.

At block 1104, the transmitter apparatus may determine a current WiFi rate. Processing may proceed from block 1104 to block 1106.

At block 1106, the transmitter apparatus may make a determination regarding whether a current buffer size of the transmitter apparatus exceeds a threshold that is determined based at least on T1 and the supported WiFi rate. For example, for an eNB or wired transmitter, the transmitter apparatus may make a determination whether a current size of the transmitter apparatus buffer is greater than or equal to a threshold corresponding to (T1*current WiFi rate). Alternatively, for a transmitter apparatus corresponding to a WLAN access point, the transmitter apparatus may determine whether a current size of the transmitter apparatus buffer is greater than or equal to a threshold corresponding to (MAX(T1,T2)*current WiFi rate). If the transmitter determines, at block 1106, that the current size of the transmitter apparatus buffer exceeds the applicable threshold, then processing may proceed from block 1106 to block 1110. However, if the transmitter determines, at block 1106, that the current size of the transmitter apparatus buffer is less than the threshold, then processing may proceed from block 1106 to block 1108.

At block 1108, the transmitter apparatus may increase the buffer size by an amount determined to ensure that the buffer size is greater than or equal to the applicable threshold, but that does not exceed the threshold by too great a margin. For example, the buffer size may be increased by (The Threshold−Current Buffer Size)+X), where X is a value selected to avoid an undesirably large buffer size. For example, X may be a midpoint of an acceptable margin above the threshold. Alternatively, X may be determined based on a number of columns or rows of a data structure of the buffer. It is also envisioned that the buffer size may be increased recursively by a fixed amount, such as one row or column at a time, until the buffer size is found to be sufficient. Processing may proceed from block 1108 to block 1114.

At block 1110, the transmitter apparatus may make a determination whether a current buffer size exceeds the applicable threshold by too great a margin. For example, the transmitter apparatus may make a determination whether a current buffer size is less than (The Threshold+2X). If the transmitter determines, at block 1110, that the current buffer size exceeds the threshold by too great a margin, then processing may proceed from block 1110 to block 1112. However, if the transmitter determines, at block 1110, that the current buffer size does not exceed the threshold by too great a margin, then processing may proceed from block 1110 to block 1114.

At block 1112, the transmitter apparatus may decrease the current buffer size when the buffer size exceeds the threshold by too great a margin. In this process, the transmitter apparatus may decrease the buffer size in such a manner as to ensure that the decreased buffer size is not less than the threshold, and in such a manner as to ensure that the decreased buffer size does not exceed the threshold by too great a margin. For example, the transmitter apparatus may decrease buffer size by ((Current Buffer Size−The Threshold)−X). It is also envisioned that the transmitter apparatus may recursively decrease the buffer size one row or column at a time until the buffer size is found to be within the acceptable margin above the threshold. Processing may proceed from block 1112 to block 1114.

At block 1114, the transmitter apparatus may transmit data of the WLAN access point transmission buffer over the WLAN. Processing may return from block 1114 to block 1100.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of scheduling and transmitting data over multiple links, the method comprising:
determining a difference between a first delay of a first link and a second delay of a second link, wherein the first delay is equal to a time duration of delivery of data over the first link, wherein the second delay is equal to a time duration of delivery of data over the second link;
adding delay to the second link when the first delay is larger than the second delay;
adding delay to the first link when the second delay is larger than the first delay; and
transmitting data, when the first delay is larger than the second delay, over the first link and the second link according to the delay added to the second link; and
transmitting data, when the second delay is larger than the first delay, over the first link and the second link according to the delay added to the first link.

2. The method of claim 1, wherein determining the difference includes determining the difference based on a backhaul delay.

3. The method of claim 1, wherein determining the difference includes estimating the difference based on round trip time.

4. The method of claim 1, wherein adding delay to the second link includes adding delay to the second link equal to an absolute value of the difference between the first delay and the second delay.

5. The method of claim 1, wherein adding delay to the first link includes adding delay to the first link equal to an absolute value of the difference between the second delay and the first delay.

6. The method of claim 1, wherein the method is performed by one of a base station, a user equipment, a wired transmitter, a network controller, and combinations thereof.

7. The method of claim 1, wherein the time duration of delivery of data over the first link includes a time duration of the data waiting in a first transmission queue and a time duration of the data being transmitted to a receiver over the first link, wherein the time duration of delivery of data over the second link includes a time duration of the data waiting in a second transmission queue and a time duration of the data being transmitted to the receiver over the second link.

8. The method of claim 1, further comprising estimating the difference between the first delay of the first link and the second delay of the second link by one or more of: a transmitter of the data, or a receiver of the data.

9. A transmitter apparatus, comprising:
means for determining a difference between a first delay of a first link and a second delay of a second link, wherein the first delay is equal to a time duration of delivery of data over the first link, wherein the second delay is equal to a time duration of delivery of data over the second link;
means for adding delay to the second link when the first delay is larger than the second delay;
means for adding delay the first link when the second delay is larger than the first delay; and
means for transmitting data, when the first delay is larger than the second delay, over the first link and the second link according to the delay added to the second link; and
means for transmitting data, when the second delay is larger than the first delay, over the first link and the second link according to the delay added to the first link.

10. The transmitter apparatus of claim 9, wherein the means for determining the difference includes means for determining the difference based on a backhaul delay.

11. The transmitter apparatus of claim 9, wherein the means for determining the difference includes means for estimating the difference based on round trip time.

12. The transmitter apparatus of claim 9, wherein the means for adding delay to the second link includes means for adding delay to the second link equal to an absolute value of the difference between the first delay and the second delay.

13. The transmitter apparatus of claim 9, wherein the means for adding delay to the first link includes means for adding delay to the first link equal to an absolute value of the difference between the second delay and the first delay.

14. The transmitter apparatus of claim 9, wherein the apparatus corresponds to one of a base station, a user equipment, a wired transmitter, a network controller, and combinations thereof.

15. The transmitter apparatus of claim 9, wherein the time duration of delivery of data over the first link includes a time duration of the data waiting in a first transmission queue and a time duration of the data being transmitted to a receiver over the first link, wherein the time duration of delivery of data over the second link includes a time duration of the data waiting in a second transmission queue and a time duration of the data being transmitted to the receiver over the second link.

16. The transmitter apparatus of claim 9, further comprising means for estimating the difference between the first delay of the first link and the second delay of the second link at one or more of: the transmitter apparatus, or a receiver of the data.

17. A computer program product comprising a non-transitory computer-readable medium having instructions recorded thereon that, when enacted by one or more computer processors, cause the one or more computer processors to carry out operations comprising:
determining a difference between a first delay of a first link and a second delay of a second link, wherein the first delay is equal to a time duration of delivery of data over the first link, wherein the second delay is equal to a time duration of delivery of data over the second link;
adding delay to the second link when the first delay is larger than the second delay;
adding delay the first link when the second delay is larger than the first delay; and
transmitting data, when the first delay is larger than the second delay, over the first link and the second link according to the delay added to the second link; and
transmitting data, when the second delay is larger than the first delay, over the first link and the second link according to the delay added to the first link.

18. The computer program product of claim 17, wherein the instructions for causing the one or more computers to carry out operations comprising determining the difference include one of:
instructions for causing the one or more computers to carry out operations comprising determining the difference based on a backhaul delay; or
instructions for causing the one or more computers to carry out operations comprising estimating the difference based on round trip time.

19. The computer program product of claim 17, wherein the instructions for causing the one or more computers to carry out operations comprising adding delay to the second link include instructions for causing the one or more computers to carry out operations comprising adding delay to the second link equal to an absolute value of the difference between the first delay and the second delay.

20. The computer program product of claim 17, wherein the instructions for causing the one or more computers to carry out operations comprising adding delay to the first link include instructions for causing the one or more computers to carry out operations comprising adding delay to the first link equal to an absolute value of the difference between the second delay and the first delay.

21. The computer program product of claim 17, wherein the one or more computer processors correspond to one or more computer processors of a transmitter apparatus corresponding to one of a base station, a user equipment, a wired transmitter, a network controller, and combinations thereof.

22. The computer program product of claim 17, wherein the time duration of delivery of data over the first link includes a time duration of the data waiting in a first transmission queue and a time duration of the data being transmitted to a receiver over the first link, wherein the time duration of delivery of data over the second link includes a time duration of the data waiting in a second transmission queue and a time duration of the data being transmitted to the receiver over the second link.

23. A transmitter apparatus, comprising:
one or more processors configured to:
determine a difference between a first delay of a first link and a second delay of a second link, wherein the first delay is equal to a time duration of delivery of data over the first link, wherein the second delay is equal to a time duration of delivery of data over the second link;
add delay to the second link when the first delay is larger than the second delay;
add delay the first link when the second delay is larger than the first delay; and
transmit data, when the first delay is larger than the second delay, over the first link and the second link according to the delay added to the second link; and
transmit data, when the second delay is larger than the first delay, over the first link and the second link according to the delay added to the first link; and
at least one memory coupled to the one or more processors.

24. The transmitter apparatus of claim 23, wherein the one or more processors are configured to determine the difference at least in part by determining the difference based on a backhaul delay.

25. The transmitter apparatus of claim 23, wherein the one or more processors are configured to determine the difference at least in part by estimating the difference based on round trip time.

26. The transmitter apparatus of claim 23, wherein the one or more processors are configured to add delay to the second link at least in part by adding delay to the second link equal to an absolute value of the difference between the first delay and the second delay.

27. The transmitter apparatus of claim 23, wherein the one or more processors are configured to add delay to the first link at least in part by adding delay to the first link equal to an absolute value of the difference between the second delay and the first delay.

28. The transmitter apparatus of claim 23, wherein the transmitter apparatus corresponds to one of a base station, a user equipment, a wired transmitter, a network controller, and combinations thereof.

29. The transmitter apparatus of claim 23, wherein the time duration of delivery of data over the first link includes a time duration of the data waiting in a first transmission queue and a time duration of the data being transmitted to a receiver over the first link, wherein the time duration of delivery of data over the second link includes a time duration of the data waiting in a second transmission queue and a time duration of the data being transmitted to the receiver over the second link.

30. The transmitter apparatus of claim 23, wherein the one or more processors are configured to estimate the difference between the first delay of the first link and the second delay of the second link at one or more of: the transmitter apparatus, or a receiver of the data.
